(19) United States
(12) Patent Application Publication
(10) Pub. No.: US 2010/0154296 A1
(43) Pub. Date: Jun. 24, 2010

(54) COAL PARTICLES BRIQUETTE WHERE THE BINDER IS LIGNIN AND METHODS AND SYSTEMS OF PREPARING THE SAME

(75) Inventor: Ravi Malhotra, Denver, CO (US)

Correspondence Address: PATTON BOGGS LLP, 1801 CALFORNIA STREET, SUITE 4900, DENVER, CO, 80202, US

(73) Assignee: Clean Coal Briquette, Inc., Lakewood, CO (US)

(21) Appl. No.: 12/643,734

(22) Filed: Dec. 21, 2009

Related U.S. Application Data
(60) Provisional application No. 61/139,962, filed on Dec. 22, 2008.

(51) Int. Cl. C10L 5/44; C10L 5/06; B30B 11/00

(52) U.S. Cl. 44/590; 44/589; 44/636; 44/594

(57) ABSTRACT

A briquette is comprised essentially of coal particles and solid lignin where the briquette does not include binders other than the lignin. A method of preparing briquettes from coal particles and lignin comprises grinding, drying, mixing, and briquetting. A system of preparing briquettes from coal particles and lignin can either be located proximally to a power plant or delivered by trucks, trains, ships, or air freight to the power plant.

### CROSS-REFERENCE TO RELATED APPLICATIONS

This application claims the benefit of U.S. Provisional Patent Application No. 61/139,962 filed Dec. 22, 2008.

### STATEMENT REGARDING FEDERALLY SPONSORED RESEARCH OR DEVELOPMENT

This application is being filed under Federal Grant No. 05-06-04463 issued by the US Department Of Commerce Economic Development Administration (EDA).

### BACKGROUND OF THE INVENTION

1. Field of the Invention

The invention relates generally to the field of renewable energy, and more particularly to the briquetting of coal particles.

2. Statement of the Problem

Thirty eight States, Guam, and the District of Columbia have adopted Renewable Portfolio Standards (RPS), which mandate that a percentage of electricity be generated from renewable resources. This percentage varies from 10 percent to 40 percent. Federal level RPS mandates are also being considered. The US Federal Government appears to be moving closer to regulating greenhouse gas emissions and putting a cap and trade framework for carbon emissions in place. Ten Northeastern states already have a cap and trade program for emissions from power plants in place.

Many coal-fired plants are now under pressure to co-fire biomass in their boilers to meet environmental requirements. This is challenging because an enormous capital expenditure is required to convert a plant to burn biomass. The biomass can clog the coal handling equipment and the uneven particle sizes cause fluctuations in the energy output. Additionally, the lower energy content of the biomass relative to coal can result in a substantial reduction in power plant efficiency, making it difficult to manage from a power generation perspective. These challenges inhibit coal-fired power plants from fully utilizing biomass as a viable fuel alternative.

In stoker-fired coal boilers used in older coal-fired power plants, coal ash is a waste product of the combustion process. Prior to burning, coal is crushed to increase combustion efficiency. This process creates coal fines that are too light to be burned. The heat and circulation of the combustion process creates a significant air current in the boiler that causes these lighter fines to travel up through the flue before they can be burned. The coal ash is captured and bagged and then taken to a landfill for disposal. Coal refuse is a waste stream from coal mining operations that is typically not used because it cannot be handled and transported easily.

Lignin is a renewable energy source commonly derived from wood, plants, or algae. For example, a significant amount of lignin is produced as a result of forest thinning. In Colorado alone, hundreds of tons are sent to landfills everyday. Sawmills also generate lignin in the form of saw dust, chips, or bark, some of which is sold as animal bedding, and the remainder sent for disposal at a landfill. A typical sawmill can generate as much as 15 ton to 25 tons of lignin a day.

Although some effort has been put into developing briquettes from coal particles and biomass, no cost-effective solution has emerged. U.S. Pat. No. 5,916,826 discloses a biomass binder where the binder is obtained by the liquefaction of biomass at a temperature between 450° F. and 700° F. and a pressure between 200 pounds per square inch (psi) and 3000 pounds per square inch (psi). The binder then is sprayed on coal particles before being mixed at a temperature of 300° F. to 400° F. U.S. Pat. No. 4,589,887 discloses a binder derived from fly ash coke. The fly ash coke is separated from fly ash through a complex floatation process. US Patent Application Publication No. 2009/0235577 teaches a binder derived from biomass and plastic polymers. This process requires careful selection of the polymer source and a temperature between 257° F. and 482° F. during mixing in order to fluidize the polymers.

The high temperatures needed to prepare the binders in the above references add cost and complexity to the manufacture of the briquettes. Use of briquettes containing polymers may require power plant operators to apply for new permits, since the characteristics of the emissions may become more harmful. Thus, it would be highly desirable to have briquettes that can be manufactured from coal particles and binders at lower temperatures. Furthermore, the briquettes should be able to be burned by power plants without producing additional new harmful emissions.

### SUMMARY OF THE INVENTION

The invention solves the above problems, as well as other problems of the prior art, and obtains the objectives of the inventor by providing compositions, processes, and devices allowing coal power plants to reclaim lost coal particles fuel in the form of power plant coal ash and coal fines from coal mines and coal processors and to maximize use of renewable materials containing lignin. In a preferred embodiment, the briquettes are made of only coal particles and lignin. The coal particles and lignin may be combined to form briquettes that are easier to process using cost-effective equipment. These briquettes allow coal particles that otherwise would be wasted to be burned more completely. Since lignin, a renewable material, is the only binder holding the briquettes together, the combustion of these briquettes is allowed under existing power plant permits for air quality, provided the plants are already permitted to burn biomass and coal. In the preferred embodiment, the lignin is at a temperature of 400° F. or less when it is added to the coal particles. More preferably, it is at a temperature of 300° F. or less; and most preferably, it is at a temperature of 200° F. or less. Further, a system of preparing briquettes from coal particles component and lignin component is described where the system is located proximally to a power plant and the finished briquettes are carried by conveyor to the boiler. Alternatively, the system is located near the sources of coal particles and lignin; and the finished briquettes are delivered to a power plant on trucks, ships, trains, or air freight.

The invention provides a briquette consisting essentially of a coal particles component and a solid lignin component where the briquette does not include binders other than solid lignin. Preferably, the moisture content of the briquette is 3 percent to 25 percent by weight, more preferably 6 percent to 18 percent by weight, and most preferably 7 percent to 12 percent by weight. Preferably, the solid lignin component is selected from the group consisting of: wood, plants, crop waste, molasses, and starches, and where the coal particles component is selected from the group consisting of: coal ash and coal refuse.

The coal particles component preferably comprises 0.01 percent to 90 percent by weight of the briquette, and the solid lignin component comprises 99.99 percent to 10 percent by weight of the briquette. More preferably, the coal particles component comprises 20 percent to 50 percent by weight of the briquette, and the solid lignin component comprises 80 percent to 50 percent by weight of the briquette. Most preferably, the coal particles component comprises 30 percent to 40 percent of the briquettes by weight, and the solid lignin component comprises 70 percent to 60 percent of the briquettes by weight.

The combustion of the briquettes preferably emits 13.08 pounds (lbs.) to 17.41 pounds (lbs.) of sulfur oxide per ton of the briquettes where the coal particles component is coal ash, and 28.8 lbs. to 38.38 lbs. of sulfur oxide per ton of the briquettes where the coal particles component is coal waste. More preferably, the combustion of the briquettes emits 10.9 lbs. to 14.51 lbs. of sulfur oxide per ton of the briquettes where the coal particles component is coal ash, and 24 lbs. to 31.98 lbs. of sulfur oxide per ton of the briquettes where the coal particles component is coal waste. Most preferably, the combustion of the briquettes emits 9.08 lbs. to 12.09 lbs. of sulfur oxide per ton of the briquettes where the coal particles component is coal ash, and 20 lbs. to 26.65 lbs. of sulfur oxide per ton of the briquettes where the coal particles component is coal waste.

The combustion of the briquettes preferably emits 3.15 lbs. to 3.47 lbs. of nitrogen oxide per ton of the briquettes where the coal particles component is coal ash, and 5.13 lbs. to 6.11 lbs. of nitrogen oxide per ton of the briquettes where the coal particles component is coal waste. More preferably, the combustion of the briquettes emits 2.63 lbs. to 2.89 lbs. of nitrogen oxide per ton of the briquettes where the coal particles component is coal ash, and 4.27 lbs. to 5.09 lbs. of nitrogen oxide per ton of the briquettes where the coal particles component is coal waste. Most preferably, the combustion of the briquettes emits 2.19 lbs. to 2.41 lbs. of nitrogen oxide per ton of the briquettes where the coal particles component is coal ash, and 3.56 lbs. to 4.24 lbs. of nitrogen oxide per ton of the briquettes where the coal particles component is coal waste.

The combustion of said briquettes preferably emits 894.14 lbs. to 1192.18 lbs. of carbon dioxide per ton of the briquettes where the coal particles component is coal ash, and 1975.41 lbs. to 2633.88 lbs. of carbon dioxide per ton of the briquettes where the coal particles component is coal waste. More preferably, the combustion of the briquettes emits 745.12 lbs. to 993.48 lbs. of carbon dioxide per ton of the briquettes where the coal particles component is coal ash, and 1646.17 lbs. to 2194.90 lbs. of carbon dioxide per ton of the briquettes where the coal particles component is coal waste. Most preferably, the combustion of the briquettes emits 620.93 lbs. to 827.90 lbs. of carbon dioxide per ton of the briquettes where the coal particles component is coal ash, and 1371.81 lbs. to 1829.08 lbs. of carbon dioxide per ton of the briquettes where the coal particles component is coal waste.

The briquette preferably has an energy content of 5,500 British Thermal Units/pound (BTU/lb.) to 12,000 British Thermal Units/pound (BTU/lb.), more preferably an energy content of 6,000 BTU/lb. to 10,000 BTU/lb., and most preferably an energy content of 6,500 BTU/lb to 9,000 BTU/lb.

The briquette is an industrial grade fuel. The briquette is an industrial grade fuel that can be used in stoker, pulverized, and cyclone boilers that burn coal or biomass as their primary fuel. Industrial grade fuels are engineered and manufactured to have high energy content of over 5000 British Thermal Units per pound (BTU/lb). This allows a boiler to burn these fuels without significant de-rating of the boiler. Plants using these fuels operate under air quality permits, which means that the fuels may not emit more than 40 lbs./ton of sulfur oxide, 9 lbs./ton of nitrogen oxide, and 5000 lbs./ton of carbon dioxide. Additionally, these fuels must withstand handling and transport by machinery such as conveyors, stackers, reclaimers, bucket elevators, shiploaders, unloaders, various shuttles, trucks, ships, air freight, hoppers and diverters. Therefore, these fuels must have a density of 56 pounds per cubic foot (lbs./cf) or greater and a particle size larger than 0.04 cubic inches.

The briquette preferably has a density of 62 lbs./cubic foot (cf) to 187 lbs./cubic foot (cf), more preferably a density of 81 to 125 lbs./cf, and most preferably a density of 106 lbs./cf.

The invention also provides a method for preparing briquettes from coal particles component and lignin component, the method comprising drying the coal particles component and lignin component, grinding the coal particles component and lignin component, mixing the coal particles component with the lignin component at ambient temperature, and pressing the mixture in a briquette roller press. Preferably, the briquettes undergo sifting in a sifter. In a preferred embodiment, the lignin component is a solid lignin component. Preferably, the mixing of the coal particles component with the lignin component comprises mixing 0.01 percent to 90 percent by weight of coal particles component mixed with 99.99 percent to 10 percent by weight of lignin component. More preferably, the mixing comprises 20 percent to 50 percent by weight of coal particles component mixed with 80 percent to 50 percent by weight of lignin component. Most preferably, the mixing comprises 30 percent to 40 percent by weight of coal particles component mixed with 70 percent to 60 percent by weight of lignin component. Prior to mixing, both the coal particles component and lignin component are preferably at a temperature of 100° F. to 220° F. More preferably, prior to mixing, both the coal particles component and lignin component are at a temperature of 130° F. to 195° F., and most preferably at a temperature of 160° F. to 170° F. In a preferred embodiment, both the coal particles component and lignin component are ground to 100 microns to 6350 microns, and most preferably to 1000 microns to 2500 microns. Preferably, after drying, the lignin component has a moisture content of 5 percent to 55 percent by weight, and the coal particles component has a moisture content of 1 percent to 30 percent by weight. More preferably, after drying, the lignin component has a moisture content of 8 percent to 25 percent by weight, and the coal particles component has a moisture content of 7 percent to 20 percent by weight. Most preferably, after drying, said lignin component has a moisture content of 11 percent to 20 percent by weight, and said coal particles component has a moisture content of 10 percent to 15 percent by weight. The briquette roller press preferably is set at a pressure of 1000 psi to 9000 psi. More preferably, the briquette roller press is set at a pressure setting of 1300 psi to 7500 psi. Most preferably, the briquette roller press is set at a pressure setting of 2000 psi to 3500 psi. The briquette roller press preferably applies pressure for 0.001 seconds to 2 seconds, and most preferably, the pressure is applied for 0.01 seconds to 0.1 seconds.

The invention further provides a system of preparing briquettes from coal particles component and lignin component comprising: a briquette delivery system; a lignin conditioning system comprising a first end and a second end; a coal particles conditioning system comprising a first end and a second end; a mixer comprising a first end and a second end; and a briquette roller press comprising a first end and a second end. The coal particles component enters the first end of the coal particles conditioning system. The lignin component enters the first end of the lignin conditioning system. The coal particles component exits the second end of the coal particles conditioning system and enters the first end of the mixer, and the lignin component exits the second end of the lignin conditioning system and enters the first end of the mixer. The mixture of the coal particles component and the lignin component exits the second end of the mixer and enters the first end of the briquette roller press, and the briquettes exit the second end of the briquette roller press and enter the briquette delivery system. Preferably, the lignin conditioning system, the coal particles conditioning system, the mixer, the briquette roller press, and the briquette delivery system are connected by a conveyor. The lignin conditioning system and coal particles conditioning system each preferably comprise a grinder and a dryer. Preferably, the briquette delivery system is connected to the boiler of a power plant. Another preference is for the briquette delivery system to comprise trucks, ships, trains, or air freight. Preferably, the coal particles component is coal ash from a power plant or coal fines from a coal mine or a coal processing plant. In a preferred embodiment, the lignin component is a solid lignin component.

The invention for the first time provides a briquette, comprising coal particles and solid lignin, where the solid lignin is the only binder. Further, the briquette is prepared utilizing cost-effective equipment that can be located proximally to a power plant, providing a reliable source of fuel with reduced emissions for the power plant. Numerous other features, objects, and advantages of the invention will become apparent from the following detailed description when read in conjunction with the accompanying drawings.

### BRIEF DESCRIPTION OF THE DRAWING

FIG. 1 is a pie chart showing the various methods of coal ash disposal;

FIG. 2 is a block diagram illustrating an embodiment of the method for making briquettes disclosed in the invention;

FIG. 3 shows an exemplary roller type briquette press used in the embodiments herein described;

FIG. 4 is a block diagram of a generalized system of preparing briquettes according to the invention proximally to a power plant;

FIG. 5 is a block diagram of a generalized system of preparing briquettes according to the invention located offsite from the power plant burning the briquettes; and

FIG. 6 is a graph of the turbine throttle pressure output of a plant burning briquettes disclosed in the invention.

### DETAILED DESCRIPTION OF THE PREFERRED EMBODIMENT

The invention provides compositions and methods of making briquettes from coal particles and lignin. The disclosure is written in terms of coal particles that are waste products of coal power plants and coal mining operations, but it can be applied to other forms of coal particles.

Older coal-fired power plants using stoker-fired coal boilers produce coal ash as a waste product of the combustion process. Prior to burning, coal is crushed to maximize surface area and, therefore, increase combustion efficiency. This process creates coal ash that is too light to be burned completely. Because heat and circulation of combustion result in a significant air current in the boiler, these fines travel out of the boiler with the hot flue gas. The coal ash is captured and bagged, and then taken to a landfill for disposal.

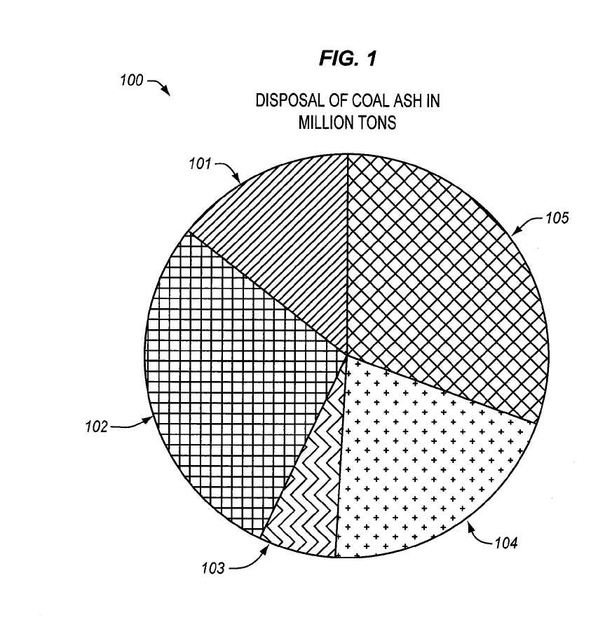

FIG. 1 shows the various ways coal ash is currently disposed. Around 10 percent of the coal ash is transported offsite shown at 101. About 21 percent is sold for uses including, but not limited to: concrete, road sub-base, flowable fill, gypsum board, and paints shown at 102. About 4.6 percent of the coal ash is disposed onsite shown at 103. A further 15 percent is disposed in ponds 104, and 22.5 percent is disposed in landfills 105. If the nearly 42 million tons of unused coal ash had been recycled, it would reduce the need for approximately 27,500 acre feet (33,925,234 m³) of landfill space.

Coal refuse, which includes coal fines, Garbage of Bituminous (GOB) and culm is a waste stream from coal mining operations that is not used because it cannot be easily cleaned, handled, or transported. In 2007, the amount of coal produced at US coal mines reached an all-time high of 1,145 million short tons; this production data includes quantities extracted from surface and underground mines, and normally excludes secondary materials removed at mines or associated preparation plants (USDOE 2007). Thus, the amount of raw mining product is higher than this 1,145 million short ton total. The amount of mining reject resulting from this production is uncertain, but up to 50 percent of the raw mined product may end up as refuse depending on the rock and impurities in the coal. Considering this 50 percent generation estimate with the 2007 coal production number, an estimate up to 1,145 million tons of coal reject may have been generated in 2007 (i.e., 50 percent of raw mined product is saleable product, while 50 percent is rejects). As an example of specific data from one state, 15 million tons of mining reject are generated annually in Virginia. Increasing coal use for electricity generation at existing plants and construction of a few new coal-fired plants lead to forecasted annual production increases that average 1.1 percent per year from 2005 to 2015. The forecasted growth in coal production is stronger from 2015 to 2030, averaging 1.8 percent per year, as new coal-fired generating capacity is added. More of these coal mining rejects will continue being accumulated, and contain energy that could be used by this invention.

An objective of the invention is to reclaim these coal particles as fuel through briquetting with lignin using cost-effective equipment and methods. Another objective of the invention is for the briquettes to be used as fuel in coal power plants without requiring new permits, modification of existing plant equipment, or reduced variance in the energy output. However, the briquettes could be used in any application where solid fuel is required, such as industrial heating applications, or even as a replacement for coal briquettes for barbeque.

The manner in which the invention makes the above scenarios possible is summarized in Table 1. The columns are organized under the headings Parameter, Coal-Based, Lignin-Based, and Briquettes. For each entry under Parameter, there are corresponding entries under Coal-Based, Lignin-Based, and Briquettes. The first entry describes the raw coal particles component for preparing the briquettes comprising coal ash, coal fines, lignite/brown coal, coal refuse, or Garbage of Bituminous (GOB). The raw lignin component is described as wood-based sawdust, solid lignin, or agricultural biomass such as crop waste, molasses, and starches. The source of coal particles component is power plants, coal processing plants, coal mining operations, or impoundment centers. Lignin component is sourced from forestry operations, wood processors, or agricultural operations. Next, the composition of the briquettes is described. Preferably, the briquettes comprise 0.01 percent to 90 percent coal particles component and 99.99 percent to 10 percent lignin component. More preferably, the briquettes are 20 percent to 50 percent coal particles component and 80 percent to 50 percent lignin component. Most preferably, the composition of briquettes is 30 percent to 40 percent coal particles component and 70 percent to 60 percent lignin component. The bulk density is preferably 100 lbs./cubic feet (cf) to 125 lbs./cubic feet (cf) for coal particles component, 10 lbs./cf to 25 lbs./cf for lignin component, and 62 lbs./cf to 187 lbs./cf for briquettes. More preferably, the bulk density is 105 lbs./cf to 117 lbs./cf for coal particles component, 13 lbs./cf to 20 lbs./cf for lignin component, and 81 lbs./cf to 125 lbs./cf for briquettes. Most preferably, the bulk density is 110 lbs./cf for coal particles component, 17 lbs./cf for lignin component, and 106 lbs./cf for briquettes. The temperature entries are divided into Before Conditioning and After Conditioning. Conditioning refers to the grinding and drying of the raw coal particles component and lignin component prior to mixing, and conditioning for briquettes refers to the air-cooling of briquettes as they exit the briquette press. The coal particles component and lignin component are both at ambient temperature prior to conditioning. After conditioning, the temperature of both the coal particles component and lignin component rises to 100° F. to 220° F. As the briquettes exit the briquette press, the temperature of the briquettes is preferably 100° F. to 220° F., more preferably 130° F. to 195° F., and most preferably 160° F. to 170° F.; they will reach ambient temperature via air-cooling before being stored or used. No heat is added during the mixing of coal particles component and lignin component. The duration of the mixing is preferably 1 minute to 30 minutes, more preferably 5 minutes to 20 minutes, and most preferably 10 minutes to 15 minutes. Preferably, prior to mixing, both the coal particles component and lignin component are ground to 100 microns to 6350 microns, and most preferably to 1000 microns to 2500 microns. The size of the finished briquettes is preferably 0.05 inches³ to 8 inches³, and most preferably 0.4 inches³.

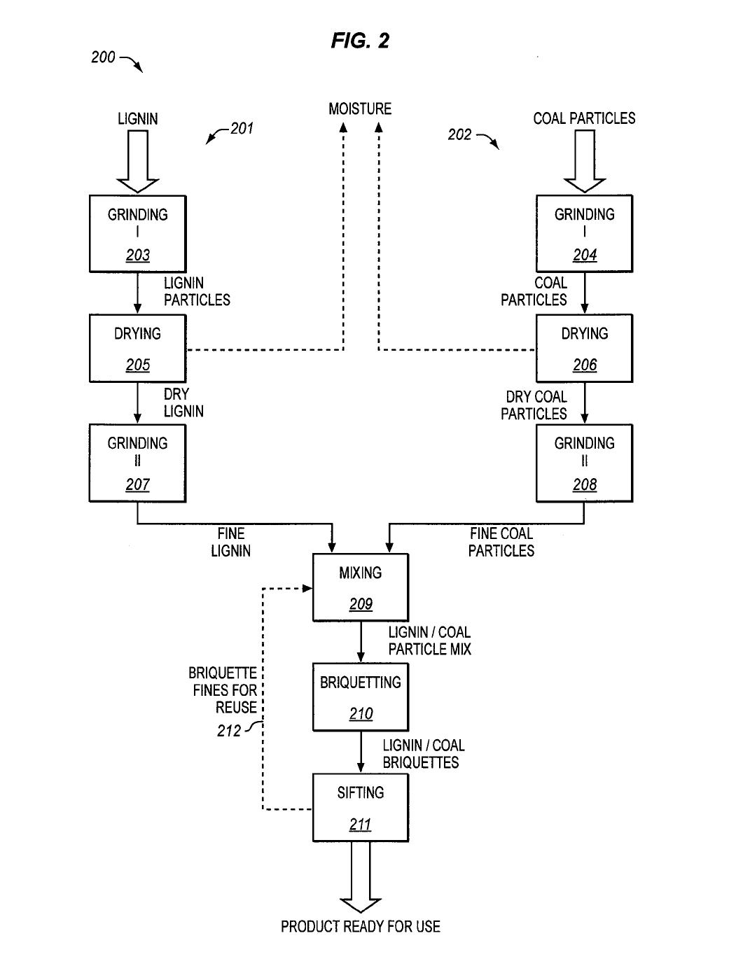

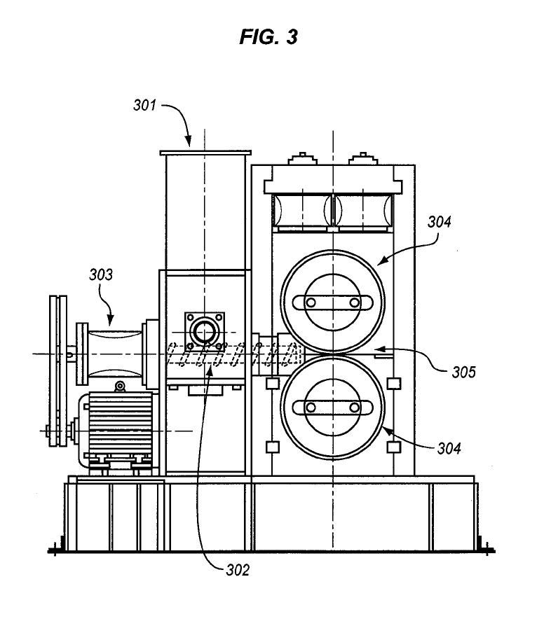

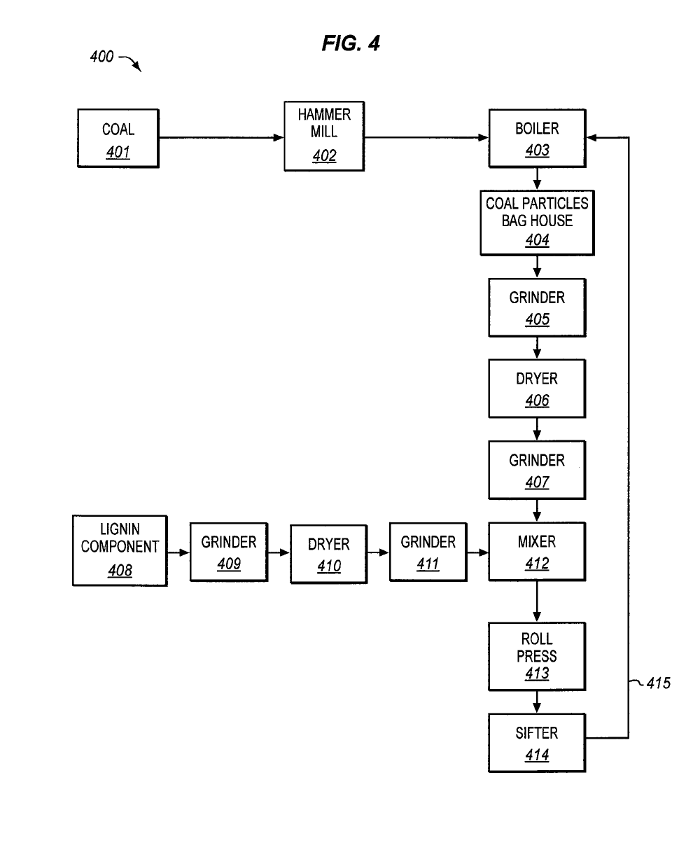

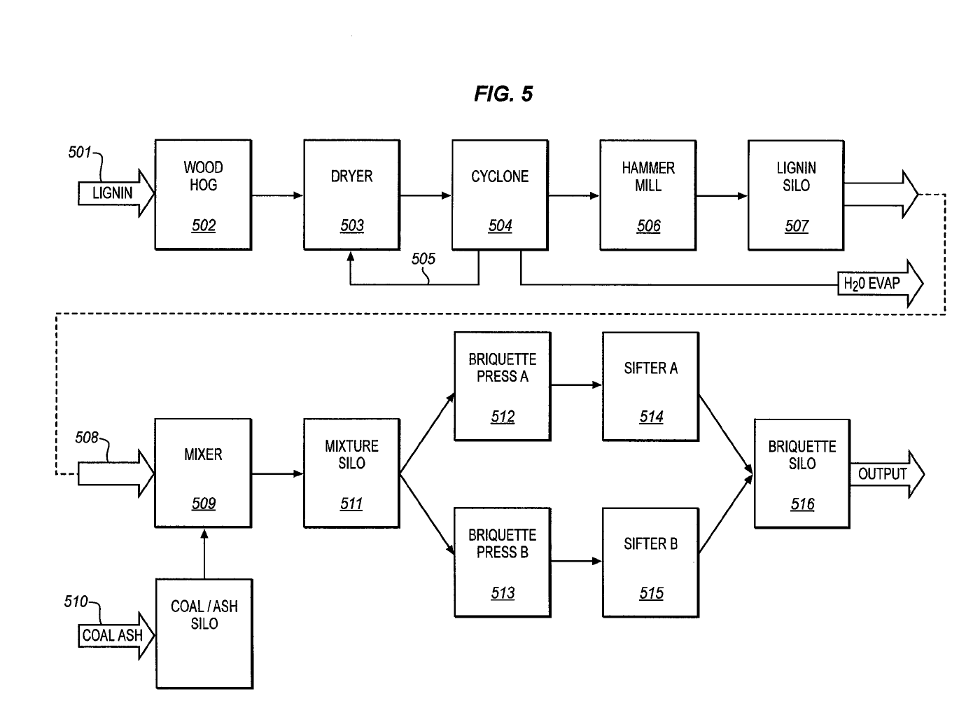

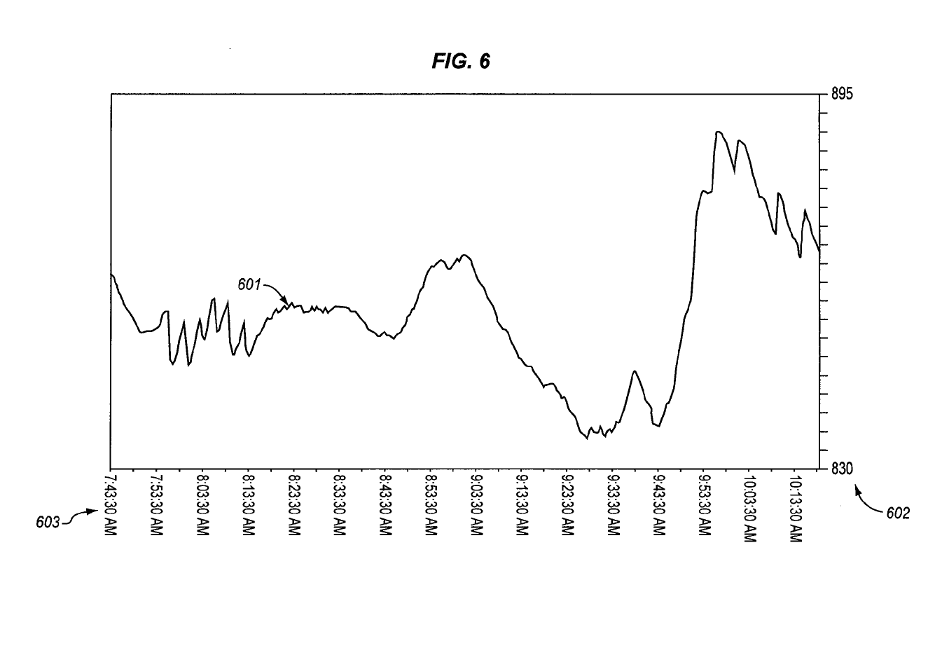

The exemplary briquette roller press that can be used to produce the briquettes is also described. The briquette press preferably applies a pressure of 1000 psi to 9000 psi, more preferably 1300 psi to 7500 psi, and most preferably 2000 psi to 3500 psi. The pressure is applied for preferably 0.001 second to 2 seconds, and most preferably, 0.01 second to 0.1 second. In addition, the results of analysis of the energy content, silicon oxide, nitrogen oxide, and carbon dioxide of the briquettes are listed. However, the invention provides much more than what is described in this table. Various other embodiments of the invention that will assist the reader in understanding how the scenarios above are made possible by the invention, and which include features that may be used in creating the scenarios, are discussed in connection with FIGS. 2 and 3. A system that utilizes some features of the invention is disclosed in FIGS. 4 and 5. FIG. 6 shows a graph of the pressure in the turbine of a power plant when the plant is burning the briquettes of the invention.

TABLE 1
SPECIFICATION OF BRIQUETTES

| Parameter | | Coal-Based | Lignin-Based | Briquettes |
|---|---|---|---|---|
| Raw Material | | Coal ash, coal | Wood-based | |
| | | fines, lignite/ | sawdust, lignin, | |
| | | brown coal, | or agricultural | |
| | | coal refuse, or | biomass (crop | |
| | | Garbage of | waste, | |
| | | Bituminous | molasses, | |
| | | (GOB) | starches) | |
| Source | | From power | Forestry | |
| | | plants, coal | operations, | |
| | | processing | wood | |
| | | plants, coal | processors, or | |
| | | mining | agricultural | |
| | | operations, or | operations | |
| | | impoundment | | |
| | | centers | | |
| Composition (Range) | | 0.01% to 90% | 99.99% to 10% | |
| (Likely Range) | | 20% to 50% | 80% to 50% | |
| (Ideal Value) | | 30% to 40% | 70% to 60% | |
| Bulk Density (Range) | | 100-125 lbs./cf | 10-25 lbs./cf | 62-187 lbs./cf |
| (Likely Range) | | 105-117 lbs./cf | 13-20 lbs./cf | 81-125 lbs./cf |
| (Ideal Value) | | 110 lbs./cf | 17 lbs/cf | 106 lbs./cf |
| Temperature | Before | Ambient | Ambient | 100° F. and |
| | Conditioning | | | 220° F. |
| | Range/Likely | | | 130° F. and |
| | | | | 195° F. |
| | Ideal | | | 160° F. and |
| | | | | 170° F. |
| | After | 100° F. and | 100° F. and | Ambient |
| | Conditioning | 220° F. | 220° F. | |
| | Range/Likely | 130° F. and | 130° F. and | |
| | | 195° F. | 195° F. | |
| | Ideal | 160° F. and | 160° F. and | |
| | | 170° F. | 170° F. | |

| | | | |
|---|---|---|---|
| Mixing Process | No heat added | No heat added | Not Applicable |
| Mixing Process Duration | 1-30 minutes | 1-30 minutes | Not Applicable |
| (Range) | | | |
| (Likely Range) | 5-20 minutes | 5-20 minutes | |
| (Ideal Value) | 10-15 | 10-15 minutes | |
| | minutes | | |
| Particle Size (Range) | 100 microns-¼ | 100 microns-¼ | 8 inches³-.05 |
| | inch | inch | inches³ |
| (Likely Range) | 1000-2500 | 1000-2500 | 0.4 inches³ |
| | microns | microns | |
| Moisture Content After | 1%-30% | 5%-55% | 3%-25% |
| Conditioning (Range) | | | |
| (Likely Range) | 7%-20% | 8%-25% | 6%-18% |
| (Ideal Value) | 10%-15% | 11%-20% | 7%-12% |
| Equipment | | | Roll type |
| | | | briquette |
| | | | machines apply |
| | | | pressures to |
| | | | particles by |
| | | | squeezing them |
| | | | between two |
| | | | rolls rotating in |
| | | | opposite |
| | | | directions. |
| | | | Cavities or |
| | | | indentations cut |
| | | | into the |
| | | | surfaces of the |
| | | | rolls to form the |
| | | | briquettes. |
| Process Pressure (Range) | N/A | N/A | 1,000 psi-9,000 psi |
| (Likely Range) | | | 1,300 psi-7,500 psi |
| (Ideal Value) | | | 2,000 psi-3,500 psi |
| Duration of the pressure | N/A | N/A | 0.001 second-2 |
| (Range) | | | seconds |
| (Likely Range) | | | 0.01 second-0.1 |
| | | | second |
| Energy Content (Range) | N/A | N/A | 5,500 BTU/lb.-12,000 BTU/lb. |
| (Likely Range) | | | 6,000 BTU/lb.-10,000 BTU/lb. |
| (Ideal Value) | | | 6,500 BTU/lb.-9,000 BTU/lb. |
| SOx Emissions, Coal Ash | N/A | N/A | 13.08 lbs./ton-17.412 lbs./ |
| Briquettes (Range) | | | ton |
| (Likely Range) | | | 10.90 lbs./ton-14.51 lbs,/ |
| | | | ton |
| (Ideal Value) | | | 9.08 lbs./ton-12.09 lbs./ |
| | | | ton |
| SOx Emissions, Coal Waste | N/A | N/A | 28.8 lbs./ton-38.38 lbs./ |
| Briquettes (Range) | | | ton |
| (Likely Range) | | | 24.0 lbs./ton-31.98 lbs./ |
| | | | ton |
| (Ideal Value) | | | 20.0 lbs./ton-26.65 lbs./ |
| | | | ton |
| NOx Emissions, Coal Ash | N/A | N/A | 3.15 lbs./ton-3.47 lbs./ |
| Briquettes (Range) | | | ton |
| (Likely Range) | | | 2.63 lbs./ton-2.89 lbs./ |
| | | | ton |
| (Ideal Value) | | | 2.19 lbs./ton-2.41 lbs./ |
| | | | ton |
| NOx Emissions, Coal Waste | N/A | N/A | 5.13 lbs./ton-6.11 lbs./ |
| Briquettes (Range) | | | ton |
| (Likely Range) | | | 4.27 lbs./ton-5.09 lbs./ |
| | | | ton |
| (Ideal Value) | | | 3.56 lbs./ton-4.24 lbs./ |
| | | | ton |
| CO₂ Emissions, Coal Ash | N/A | N/A | 894.14 lbs./ton-1192.18 lbs./ |
| Briquettes (Range) | | | ton |
| (Likely Range) | | | 745.12 lbs./ton-993.48 lbs,/ |
| | | | ton |
| (Ideal Value) | | | 620.93 lbs./ton-827.90 lbs./ |
| | | | ton |
| CO₂ Emissions, Coal Waste | N/A | N/A | 1,975.41 lbs./ |
| Briquettes (Range) | | | ton-2,633.88 lbs./ |
| | | | ton |
| (Likely Range) | | | 1,646.17 lbs./ |
| | | | ton-2,194.90 lbs./ |
| | | | ton |
| (Ideal Value) | | | 1371.81 lbs./ |
| | | | ton-1,829.08 lbs./ |
| | | | ton |

FIG. 2 is a block diagram illustrating an embodiment of the method disclosed herein, for an understanding, but not intended to be the only embodiment or a limiting embodiment. Lignin 201 is a natural resin present in wood and plants that allows the briquettes to bind together without additional binders. Lignin is the result of the irreversible removal of water from sugars, creating aromatic compounds through the phenylpropanoid pathway. Lignin polymers are cross-connected structures with molecular weights on the order of 10,000 atomic mass units (amu). Lignin forms an integral part of walls of cells such as sclereids, xylary fibers, and tracheids, resulting in the strength of wood. Exemplary solid lignin component in the embodiments 200 herein include trees. In Colorado for example, solid lignin components may be comprised primarily of pine trees such as the Ponderosa Pine, which is readily available in the Rocky Mountain area. As a result of forest thinning, an average of 15 tons/acre to 20 tons/acre of solid lignin components derived from pine trees are available. A further 35 tons/day of tree-derived lignin is generated by a typical saw mill. While lignin occurs naturally in wood-based saw dust or agricultural biomass including, but not limited to, crop waste, molasses, and starches, it is also available as by-products of paper-making and ethanol distillation. Other types of lignin can be used as long as an adequate amount of lignin is present.

The coal particles component 202 as described above, include, but are not limited to, coal ash and coal fines that are sourced from power plants, coal processing plants, coal mining operations, or impoundment centers. The lignin component 201 and coal particles component 202 are reduced to less than an inch using grinders 203 and 204. This results in components with greater surface areas which enable more efficient and effective drying. Exemplary grinders include, but are not limited to, wood chippers, wood hogs, hammer mills, and screens.

The reduced lignin component is dried 205 to achieve a moisture content of 5 percent to 55 percent. The reduced coal particles are dried 206 to achieve a moisture content of 1 percent to 30 percent. Dryers that may be used include, but are not limited to, ovens and systems utilizing methods including, but not limited to, electric resistive and inductive devices, natural gas, biomass, and recovered heat from other sources.

After drying, the lignin component 207 and coal particles 208 undergo grinding. In a preferred embodiment, the lignin component is ground to a size of 100 microns to 6,350 microns, and the coal particles component is ground to a size of 100 microns to 6,350 microns. Most preferably, the lignin component is ground to a size of 1,000 microns to 2,500 microns, and the coal particles component is ground to a size of 1,000 microns to 2,500 microns. The grinders of the embodiment include, but are not limited to, wood chippers, hammer mills, and screens.

The drying and grinding result in the temperature of the coal particles component and lignin component to rise to 100° F. and 220° F., respectively, from ambient temperature. Depending on the moisture content and particle size of the raw components, the amount of drying and grinding can be reduced, leading to lower temperature of the components. More preferably, the temperature of the components is 130° F. to 195° F. Most preferably, the temperature of the components is 160° F. to 170° F.

After grinding, the coal particles component and lignin component are mixed in a mixer 209. It is a feature of the invention that the mixer operates at ambient temperature without the application of heat. The mixture preferably comprises 0.01 percent to 90 percent by weight of coal particles component and10 percent to 99.99 percent by weight of solid lignin component. More preferably, the mixture comprises 20 percent to 50 percent coal particles component by weight and 80 percent to 50 percent solid lignin component by weight. The mixture most preferably comprises 30 percent to 40 percent by weight of coal particles component and 70 percent to 60 percent by weight of solid lignin component.

The mixer 209 includes, but is not limited to, rotary continuous mixers. In an exemplary embodiment of the invention, a Munson Rotary Continuous Mixer Model #36×9 was utilized. Preferably, the mixture has a residence time in the mixer of 1 minute to 30 minutes. More preferably, the residence time is 5 minutes to 20 minutes. Most preferably, the residence time is 10 minutes to 15 minutes.

A feature of the invention is the use of a briquette roller press 210 to press the mixture into briquettes. Preferably, the briquette roller press is configured to apply a pressure of 1,000 psi to 9,000 psi. More preferably, the briquette press is configured to apply a pressure of 1,300 psi to 7,500 psi. In the most preferred embodiment, the briquette press is configured to apply a pressure of 2,000 psi to 3,500 psi. Preferably, the briquette press applies pressure for the duration of 0.001 second to 2 seconds. More preferably, the briquette roller press applies pressure for 0.01 second to 0.1 second. The finished briquettes undergo sifting 211 to trim off the edges and remove any loose dust, thus minimizing the amount of loose dust that would potentially be wasted in the burning process. The sifter is a multiple bearing screener with a drive. The drive vibrates the equipment assembly so that loose edges and powder are knocked off the finished briquettes and recycled back into the system as shown at 212. The vibrating screener can have multiple screen decks to capture or separate different size particles. The sifter also acts like a conveyor; the briquettes move along a belt or inclined screen as they are vibrated so that they make it to the next conveyor.

The briquette that is formed is strongly bound and has a density preferably of 62 lbs./cf to 187 lbs./cf, more preferably a density of 81 lbs./cf to 125 lbs./cf, and most preferably a density of 106 lbs./cf. Sub-bituminous coal has a density of 56 lbs./cf and anthracite coal, also known as hard coal, has a density of 117 lbs./cf. The high density of the briquettes of the invention ensures that the briquettes retain their shape even after handling and transport by machinery such as conveyors, stackers, reclaimers, bucket elevators, shiploaders, unloaders, various shuttles, hoppers, and diverters. Moreover, the briquettes can withstand storage in silos or stockpiles as is commonly required when awaiting delivery to distant power plants.

FIG. 3 shows an exemplary roller type briquette press used in the embodiments herein described. The mixture of coal particles and lignin 301 is fed into the screw feeder 302. The screw feeder 302, driven by screw drive 303, carries the mixture to the rolls 304. Roller type briquette presses apply pressure to the mixture by compressing the mixture between two rolls 304 rotating in opposite directions. Cavities or indentations cut into the surfaces of the rolls form the briquettes 305. In one embodiment, a Komarek B220 Roll Press running at 80 percent screw speed was used to produce 3 tons a day of 1 inch diameter and 2 inch long briquettes. The embodiment described is only exemplary, and any briquetting press may be used provided the press has sufficient throughput and can withstand the excessive wear due to the abrasive characteristics of the coal particles and lignin mixture.

The briquette of the invention preferably has an energy content of 5,500 BTU/lb. to 12,000 BTU/lb. More preferably, the energy content is 6,000 BTU/lb. to 10,000 BTU/lb. Most preferably, the energy content is 6,500 BTU/lb. to 9,000 BTU/lb., which represents only a 10 percent to 25 percent reduction in energy content relative to coal typically burned in a coal-fired power plant. The briquette is an industrial grade fuel that can be used in stoker, pulverized, and cyclone boilers that burn coal or biomass as their primary fuel. Industrial grade fuels are engineered and manufactured to have high energy content of over 5,000 BTU/lb. This allows a boiler to burn these fuels without significant de-rating of the boiler. Plants using these fuels operate under air quality permits, which means that the fuels may not emit more than 40 lbs./ton of sulfur oxide, 9 lbs./ton of nitrogen oxide, and 5,000 lbs./ton of carbon dioxide. Additionally, these fuels must withstand handling and transport by machinery such as conveyors, stackers, reclaimers, bucket elevators, shiploaders, unloaders, various shuttles, trucks, ships, air freight, hoppers and diverters. Therefore, these fuels must have a density of 56 lbs./cf or greater and a particle size larger than 0.04 cubic inches.

Preferably, the combustion of the briquette of the invention in the boiler of a coal-fired plant results in the emission of 13.08 lbs. to 17.41 lbs. of sulfur oxide per ton of the briquettes where the coal particles component in the briquettes is coal ash, and 28.8 lbs. to 38.38 lbs. of sulfur oxide per ton of the briquettes where the coal particles component in the briquettes is coal waste. More preferably, the combustion of the briquette of the invention in the boiler of a coal-fired plant results in the emission of 10.9 lbs. to 14.51 lbs. of sulfur oxide per ton of the briquettes where the coal particles component in the briquettes is coal ash, and 24 lbs. to 31.98 lbs. of sulfur oxide per ton of the briquettes where the coal particles component in the briquettes is coal waste.

Most preferably, the combustion of the briquettes emits 9.08 lbs. to 12.09 lbs. of sulfur oxide per ton of the briquettes where the coal particles component in the briquettes is coal ash, and 20 lbs. to 26.65 lbs. of sulfur oxide per ton of the briquettes where the coal particles component in the briquettes is coal waste. Relative to the sulfur oxide emitted by a stoker power plant burning sub-bituminous coal alone, this is an 82.7 percent to 87 percent reduction when the coal particles component is coal ash, and a 61.9 percent to 71.4 percent reduction when the coal particles component is coal waste. The sulfur oxide as used in this disclosure includes any possible combinations of sulfur and oxygen.

Preferably, the combustion of the briquette of the invention in the boiler of a coal-fired plant results in the emission of 3.15 lbs. to 3.47 lbs. of nitrogen oxide per ton of the briquettes where the coal particles component in the briquettes is coal ash, and 5.13 lbs. to 6.11 lbs. of nitrogen oxide per ton of the briquettes where the coal particles component in the briquettes is coal waste. More preferably, the combustion of the briquette of the invention in the boiler of a coal-fired plant results in the emission of 2.63 lbs. to 2.89 lbs. of nitrogen oxide per ton of the briquettes where the coal particles component in the briquettes is coal ash, and 4.27 lbs. to 5.09 lbs. of nitrogen oxide per ton of the briquettes where the coal particles component in the briquettes is coal waste.

Most preferably, the combustion of the briquettes emits 2.19 lbs. to 2.41 lbs. of nitrogen oxide per ton of the briquettes where the coal particles component in the briquettes is coal ash, and 3.56 lbs. to 4.24 lbs. of nitrogen oxide per ton of the briquettes where the coal particles component in the briquettes is coal waste. Relative to the nitrogen oxide emitted by a stoker power plant burning sub-bituminous coal alone, this is a 72.6 percent to 75.2 percent reduction when the coal particles component is coal ash, and a 51.8 percent to 59.6 percent reduction when the coal particles component is coal waste. The nitrogen oxide as used in this disclosure includes any possible combinations of nitrogen and oxygen.

Preferably, the combustion of the briquettes of the invention in the boiler of a coal-fired plant results in the emission of 894.14 lbs. to 1,192.18 lbs. of carbon dioxide per ton of the briquettes where the coal particles component in the briquettes is coal ash, and 1,975.41 lbs. to 2,633.88 lbs. of carbon dioxide per ton of the briquettes where the coal particles component in the briquettes is coal waste. More preferably, the combustion of the briquettes emits 745.12 lbs. to 993.48 lbs. of carbon dioxide per ton of the briquettes where the coal particles component in the briquettes is coal ash, and 1,646.17 lbs. to 2,194.90 lbs. of carbon dioxide per ton of the briquettes where the coal particles component in the briquettes is coal waste.

Most preferably, the combustion of the briquettes emits 620.93 lbs. to 827.90 lbs. of carbon dioxide per ton of the briquettes where the coal particles component in the briquettes is coal ash, and 1,371.81 lbs. to 1,829.08 lbs. of carbon dioxide per ton of the briquettes where the coal particles component in the briquettes is coal waste. Relative to the carbon dioxide emitted by a stoker power plant burning sub-bituminous coal alone, this is an 82.8 percent to 87.1 percent reduction when the coal particles component is coal ash, and a 62 percent to 71.5 percent reduction when the coal particles component is coal waste.

FIG. 4 is a block diagram illustrating an embodiment of the invention wherein the large scale production of briquettes is located proximally to a coal power plant. The system 400 consists of an embodiment of a method of producing briquettes as disclosed above. Coal particles from the boiler 403 are collected in the bag house 404. As explained above, these coal particles are ground 405, dried 406, and further ground 407. The coal particles component then is fed into the mixer 412 with the already ground 409, dried 410, and further ground 411 lignin component. The mixture is fed into a briquette roll press 413. The briquettes produced by the press are transported via conveyor 415 to the boiler of a coal power plant 403. In coal-fired plants, coal must be reduced by a hammer mill 402 before reaching the boiler. The briquettes produced by this embodiment can bypass this step, since the briquettes are already reduced by the briquette press. Alternatively, the briquettes are put through a sifter 414 so that loose edges and powder are knocked off. Removal of the reduction step results in a continuous flow of briquettes to the boiler. The embodiment described is only exemplary and there are no limitations on having the boiler of the power plant co-fire both coal and briquettes concurrently.

Embodiments of the invention include systems wherein the large scale production of briquettes is located where coal ash and coal fines are available but far from the power plant that will be using the briquettes as fuel. These locations include, but are not limited to, stoker-fired pulverized coal boiler power plants and coal mines. FIG. 5 shows an exemplary embodiment where a mechanical conveyor feeds more than 14 tons/day of lignin 501 into a wood hog 502 for grinding. The reduced lignin then is transported by conveyor to dryer 503 and cyclone 504. Lignin requiring further drying is fed back into the dryer 505 by pneumatic conveyor. The dried lignin is further reduced in the hammer mill 506 and conveyed to a silo 507. The pneumatic conveyor 508 carries lignin to the mixer 509. Coal ash 510 is fed into the mixer 509 by pneumatic conveyor. The mixture then is transported to a mixture silo 511. Two conveyors each carry the mixture to two briquetting presses 512 and 513. The presses are each connected by conveyor to sifters 514 and 515. The finished briquettes are stored in the briquette silo 516 for transport. As discussed above, the briquettes produced are durably bound together and can withstand subsequent handling and transport. The briquettes produced from the embodiments herein can be delivered to the power plant by modes of transport including, but not limited to, trains, barges, trucks, or air freight.

A test burning of the briquettes of the invention was conducted at the Aquila Coal Power Plant in Ca\ddot{n} on City, Colo. FIG. 6 is a chart of the plant's turbine throttle pressure when briquettes of the invention are burned in the boiler of the plant.

The line 601 is the turbine throttle pressure plotted against time 603 and pressure 602 in pounds per square inch (psi). Between 9 AM and 9:45 AM, briquettes of the invention were directly fed into the boiler. The introduction of the briquettes caused an expected reduction in steam pressure that was small enough that the boiler furnace was de-rated by only 3 percent. The lower BTU of the briquettes relative to coal as described above will result in the expected lower output from the boiler leading to lower pressure in the turbine. However, FIG. 6 also shows that the 3 percent reduction in the turbine pressure is within the tolerances of the turbine that will not cause a disruption in the operation of the plant. Further, continuous delivery to a boiler of briquettes with consistent energy content results in a reliable power flow allowing stable power plant operations.

A feature of the invention is that the coal particles component and lignin component are provided at ambient temperature; that is, they are provided at the temperature of their surroundings and preferably there is no heating of the lignin component and coal particles component other than the natural heating that takes place in the processes of the invention. The drying and grinding processes naturally heat the materials, and the materials then enter into the roller press at the ambient temperature at which they exit the drying and grinding processes. The pressing process also naturally heats the materials. If the lignin is obtained from other processing systems, such as an ethanol production system, its ambient temperature may be in a higher range. The point is that no additional heating systems are required, reducing cost. Further, since no high temperature heating is used, the materials can be handled without protecting the system and workers from excessive heat. In particular, prior art processes using lignin as the only binder required heating the lignin to such high temperatures that special high temperature processing machinery and procedures had to be used. Further, in such prior art processes, the lignin must be allowed to cool before conventional handling can be implemented; and when the lignin cooled, it was difficult to remove from surfaces, requiring more expensive maintenance. The feature of not adding heat other than that used in the natural processes simplifies the manufacture of the briquettes and lessens the cost. In the preferred embodiment, the lignin component is at a temperature of 400° F. or less when it is added to the coal particles. More preferably, it is at a temperature of 300° F. or less, and most preferably it is at a temperature of 200° F. or less. Generally, the lignin component is at an ambient temperature of about 100° F. to 220° F. when it is mixed with the coal particles component; more preferably, the ambient temperature at the time of mixing is between 130° F. and 195° F.; and most preferably, the ambient temperature at the time of mixing is between 160° F. and 170° F. Moreover, the process even works when the components have set for a while after the drying and grinding steps so that the ambient temperature becomes lower, i.e., the temperature of the surroundings is at approximately room temperature, i.e., 68° F. to 77° F. and/or the normal temperatures during the day in temperate or hot climates, i.e., at about 86° F. to 104° F., though a continuous process that uses the higher ambient temperatures is preferred.

There has been described a briquette comprising coal particles component and lignin component, a method of preparing the briquette, and a system utilizing the briquettes in a power plant. It should be understood that the particular embodiments shown in the drawings and described within this specification are for purposes of example and should not be construed to limit the invention, which will be described in the claims below. Further, it is evident that those skilled in the art may now make numerous uses and modifications of the specific embodiment described without departing from the inventive concepts. Equivalent structures and processes may be substituted for the various structures and processes described; the sub-processes of the inventive method may, in some instances, be performed in a different order; or a variety of different materials and elements may be used. Consequently, the invention is to be construed as embracing each and every novel feature and novel combination of features present in and/or possessed by the apparatus and methods described.

It should also be noted that ratios, concentrations, amounts, and other numerical data may be expressed herein in a range format. It is to be understood that such as range format is used for convenience and brevity; thus, it should be interpreted in a flexible manner to include not only the numerical values explicitly recited as the limits of the range but also to include all of the individual numerical values or sub-ranges encompassed within that range as if each numerical value and sub-range is explicitly recited.

We claim:

1. A briquette consisting essentially of:
a coal particles component; and
a solid lignin component wherein said briquette does not include binders other than said solid lignin component.

2. The briquette as in claim 1 wherein the moisture content of said briquette is 3 percent to 25 percent.

3. The briquette as in claim 1 wherein the moisture content of said briquette is 6 percent to 18 percent.

4. The briquette as in claim 1 wherein the moisture content of said briquette is 7 percent to 12 percent.

5. The briquette as in claim 1 wherein said solid lignin component is selected from the group consisting of: wood, plants, crop waste, molasses, and starches, and wherein said coal particles component is selected from the group consisting of: coal ash and coal refuse.

6. The briquette as in claim 1 wherein said coal particles component comprises 0.01 percent to 90 percent by weight of the briquette, and wherein said solid lignin component comprises 10 percent to 99.99 percent by weight of the briquette.

7. The briquette as in claim 1 wherein said coal particles component comprises 20 percent to 50 percent by weight of the briquette, and wherein said solid lignin component comprises 80 percent to 50 percent by weight of the briquette.

8. The briquette as in claim 1 wherein said coal particles component comprises 30 percent to 40 percent of the briquettes by weight, and wherein said solid lignin component comprises 70 percent to 60 percent of the briquettes by weight.

9. The briquette as in claim 1 wherein the combustion of said briquettes emits 13.08 lbs. to 17.41 lbs. of sulfur oxide per ton of said briquettes wherein said coal particles component is coal ash, and 28.8 lbs. to 38.38 lbs. of sulfur oxide per ton of said briquettes wherein said coal particles component is coal waste.

10. The briquette as in claim 1 wherein the combustion of said briquettes emits 10.9 lbs. to 14.51 lbs. of sulfur oxide per ton of said briquettes wherein said coal particles component is coal ash, and 24 lbs. to 31.98 lbs. of sulfur oxide per ton of said briquettes wherein said coal particles component is coal waste.

11. The briquette as in claim 1 wherein the combustion of said briquettes emits 9.08 lbs. to 12.09 lbs. of sulfur oxide per ton of said briquettes wherein said coal particles component is coal ash, and 20 lbs. to 26.65 lbs. of sulfur oxide per ton of said briquettes wherein said coal particles component is coal waste.

12. The briquette as in claim 1 wherein the combustion of said briquettes emits 3.15 lbs. to 3.47 lbs. of nitrogen oxide per ton of said briquettes wherein said coal particles component is coal ash, and 5.13 lbs. to 6.11 lbs. of nitrogen oxide per ton of said briquettes wherein said coal particles component is coal waste.

13. The briquette as in claim 1 wherein the combustion of said briquettes emits 2.63 lbs. to 2.89 lbs. of nitrogen oxide per ton of said briquettes wherein said coal particles component is coal ash, and 4.27 lbs. to 5.09 lbs. of nitrogen oxide per ton of said briquettes wherein said coal particles component is coal waste.

14. The briquette as in claim 1 wherein the combustion of said briquettes emits 2.19 lbs. to 2.41 lbs. of nitrogen oxide per ton of said briquettes wherein said coal particles component is coal ash, and 3.56 lbs. to 4.24 lbs. of nitrogen oxide per ton of said briquettes wherein said coal particles component is coal waste.

15. The briquette as in claim 1 wherein the combustion of said briquettes emits 894.14 lbs. to 1,192.18 lbs. of carbon dioxide per ton of said briquettes wherein said coal particles component is coal ash, and 1,975.41 lbs. to 2,633.88 lbs. of carbon dioxide per ton of said briquettes wherein said coal particles component is coal waste.

16. The briquette as in claim 1 wherein the combustion of said briquettes emits 745.12 lbs. to 993.48 lbs. of carbon dioxide per ton of said briquettes wherein said coal particles component is coal ash, and 1,646.17 lbs. to 2,194.90 lbs. of carbon dioxide per ton of said briquettes wherein said coal particles component is coal waste.

17. The briquette as in claim 1 wherein the combustion of said briquettes emits 620.93 lbs. to 827.90 lbs. of carbon dioxide per ton of said briquettes wherein said coal particles component is coal ash, and 1,371.81 lbs. to 1,829.08 lbs. of carbon dioxide per ton of said briquettes wherein said coal particles component is coal waste.

18. The briquette as in claim 1 wherein said briquette has an energy content of 5,500 BTU/lb. to 12,000 BTU/lb.

19. The briquette as in claim 1 wherein said briquette has an energy content of 6,000 BTU/lb. to 10,000 BTU/lb.

20. The briquette as in claim 1 wherein said briquette has an energy content of 6,500 BTU/lb. to 9,000 BTU/lb.

21. The briquette as in claim 1 wherein the briquette is an industrial grade fuel.

22. The briquette as in claim 1 wherein the density of said briquette is 62 lbs./cf to 187 lbs./cf.

23. The briquette as in claim 1 wherein the density of said briquette is 81 lbs./cf to 125 lbs/cf.

24. The briquette as in claim 1 wherein the density of said briquette is 106 lbs./cf.

25. A method of preparing briquettes from coal particles component and lignin component, the method comprising:
drying said lignin component and said coal particles component;
grinding said lignin component and said coal particles component;
mixing said coal particles component with said lignin component; and
pressing the mixture in a briquette roller press.

26. The method of preparing briquettes from coal particles component and lignin component as in claim 25 wherein said lignin component is a solid lignin component.

27. The method of preparing briquettes from coal particles component and lignin component as in claim 25 wherein said mixing of said coal particles component with said lignin component is at ambient temperature.

28. The method of preparing briquettes from coal particles component and lignin component as in claim 25 wherein said briquettes are sifted through a sifter.

29. The method of preparing briquettes from coal particles component and lignin component as in claim 25 wherein said mixing comprises mixing 0.01 percent to 90 percent by weight said coal particles component with 99.99 percent to 10 percent by weight said lignin component.

30. The method of preparing briquettes from coal particles component and lignin component as in claim 25 wherein said mixing comprises mixing 20 percent to 50 percent by weight said coal particles component with 80 percent to 50 percent by weight said lignin component.

31. The method of preparing briquettes from coal particles component and lignin component as in claim 25 wherein said mixing comprises mixing 30 percent to 40 percent by weight said coal particles component with 70 percent to 60 percent by weight said lignin component.

32. The method of preparing briquettes from coal particles component and lignin component as in claim 25 wherein after said grinding and drying said lignin component is at a temperature of 100° F. to 220° F., and said coal particles component is at a temperature of 100° F. to 220° F.

33. The method of preparing briquettes from coal particles component and lignin component as in claim 25 wherein after said grinding and drying said lignin component is at a temperature of 130° F. to 195° F., and said coal particles component is at a temperature of 130° F. to 195° F.

34. The method of preparing briquettes from coal particles component and lignin component as in claim 25 wherein after said grinding and drying said lignin component is at a temperature of 160° F. to 170° F., and said coal particles component is at a temperature of 160° F. to 170° F.

35. The method of preparing briquettes from coal particles component and lignin component as in claim 25 wherein said lignin component is ground to 100 microns to 6,350 microns, and said coal particles component is ground to 100 microns to 6,350 microns.

36. The method of preparing briquettes from coal particles component and lignin component as in claim 25 wherein said lignin component is ground to 1,000 microns to 2,500 microns, and said coal particles component is ground to 1,000 microns to 2,500 microns.

37. The method of preparing briquettes from coal particles component and lignin component as in claim 25 wherein after drying said lignin component has a moisture content of 5 percent to 55 percent by weight, and said coal particles component has a moisture content of 1 percent to 30 percent by weight.

38. The method of preparing briquettes from coal particles component and lignin component as in claim 25 wherein after drying said lignin component has a moisture content of 8 percent to 25 percent by weight, and said coal particles component has a moisture content of 7 percent to 20 percent by weight.

39. The method of preparing briquettes from coal particles component and lignin component as in claim 25 wherein after drying said lignin component has a moisture content of 11 percent to 20 percent by weight, and said coal particles component has a moisture content of 10 percent to 15 percent by weight.

40. The method of preparing briquettes from coal particles component and lignin component as in claim 25 wherein the briquette roller press is at a pressure setting of 1,000 psi to 9,000 psi.

41. The method of preparing briquettes from coal particles component and lignin component as in claim 25 wherein the briquette roller press is at a pressure setting of 1,300 psi to 7,500 psi.

42. The method of preparing briquettes from coal particles component and lignin component as in claim 25 wherein the briquette roller press is at a pressure setting of 2,000 psi to 3,500 psi.

43. The method of preparing briquettes from coal particles component and lignin component as in claim 25 wherein the briquette roller press applies pressure for 0.001 second to 2 seconds.

44. The method of preparing briquettes from coal particles component and lignin component as in claim 25 wherein the briquette roller press applies pressure for 0.01 second to 0.1 second.

45. A system of preparing briquettes from coal particles component and lignin component comprising:
a briquette delivery system;
a lignin conditioning system comprising a first end and a second end;
a coal particles conditioning system comprising a first end and a second end;
a mixer comprising a first end and a second end;
a briquette roller press comprising a first end and a second end;
wherein said coal particles component enters said first end of said coal particles conditioning system;
wherein said lignin component enters said first end of said lignin conditioning system;
wherein said coal particles component exits said second end of said coal particles conditioning system and enters said first end of said mixer;
wherein said lignin component exits said second end of said lignin conditioning system and enters said first end of said mixer;
wherein the mixture of said coal particles component and said lignin component exits said second end of said mixer and enters said first end of said briquette roller press; and
wherein said briquettes exit said second end of said briquette roller press and enter said briquette delivery system.

46. The system as in claim 45 wherein said lignin conditioning system, said coal particles conditioning system, said mixer, said briquette roller press, and said briquette delivery system are connected by a conveyor.

47. The system as in claim 45 wherein said briquette delivery system is connected to the boiler of a power plant.

48. The system as in claim 45 wherein said briquette delivery system comprises trucks, ships, trains, or air freight.

49. The system as in claim 45 wherein said lignin conditioning system comprises a grinder and a dryer.

50. The system as in claim 45 wherein said coal particles conditioning system comprises a grinder and a dryer.

51. The system as in claim 45 wherein said lignin component is a solid lignin component.

52. The system as in claim 45 wherein said coal particles component is selected from the group consisting of: coal ash from a power plant, and coal fines from a coal mine or a coal processing plant.
